(19) United States
(12) Patent Application Publication
(10) Pub. No.: US 2010/0295456 A1
(43) Pub. Date: Nov. 25, 2010

(54) TABLE LAMP FOR PROTECTING EYES

(76) Inventor: Hun-Yuan Ko, Taipei City (TW)

Correspondence Address: Chien-Hui Su, P. O. Box 70-121 Taichung, Taichung City, 40899, TW

(21) Appl. No.: 12/468,875

(22) Filed: May 20, 2009

(51) Int. Cl. H05B 37/02

(52) U.S. Cl. 315/154; 315/153

(57) ABSTRACT

A table lamp for protecting eyes includes a base and an illuminator extended from the base. The illuminator includes a sensation controlling module, multiple white LEDs respectively electrically connected to the sensation controlling module, and multiple RGB LED sets respectively electrically connected to the sensation controlling module. The sensation controlling module automatically detects an environmental illumination and an environmental color temperature. The sensation controlling module automatically adjusts an integrated illumination and an integrated color temperature of the illuminator for coordinating to different environments.

### BACKGROUND OF THE INVENTION

1. Field of the Invention

The present invention relates to a table lamp, and more particularly to a table lamp for protecting eyes.

2. Description of Related Art

A retina has two different kinds of optic cells, including cones cells and rod cells. The amount of the cone cells and the rod cells is about one hundred sixty million to one hundred eighty million. The function of the cone cells is to differentiate colors and to distinguish details of a vision. The function of the rod cell is to identify the light and the shade.

A conventional table lamp is used a tungsten lamp or a mercury vapor lamp as an emitting source thereof. However, a power consumption of the tungsten lamp is high such that the cost is high. The mercury vapor lamp is easily flickered such that the eyes are damaged. A color temperature of the conventional table lamp is not adjustable such that the temperature of the conventional table lamp can not coordinate to a temperature of the environment. An illumination of the conventional table lamp may be manually adjustable. The illumination is set based on an illumination of the environment. When the time shifting, such as the time shifts from the nightfall to the night (or the time shifts from daybreak to the morning), the illumination of the conventional table lamp can not automatically coordinate to an illumination of the environment such that the illumination of the conventional table lamp is not suitable for the changes of the illumination of the environment.

The present invention has arisen to mitigate and/or obviate the disadvantages of the conventional table lamp.

### SUMMARY OF THE INVENTION

The main objective of the present invention is to provide an improved table lamp for protecting eyes.

To achieve the objective, a table lamp for protecting eyes in accordance with the present invention comprises a base and an illuminator extended from the base. The illuminator includes a sensation controlling module, multiple white LEDs respectively electrically connected to the sensation controlling module, and multiple RGB LED sets respectively electrically connected to the sensation controlling module. Each RGB LED set includes a red LED, a green LED, and a blue LED. The sensation controlling module automatically detects an environmental illumination and an environmental color temperature. The sensation controlling module automatically adjusts an integrated illumination of the multiple white LEDs and the multiple RGB LED sets for coordinating to the environmental illumination. The sensation controlling module automatically adjusts an integrated color temperature of multiple RGB LED sets for coordinating the environmental color temperature.

In accordance with another aspect of the present invention, the illuminator comprises multiple LED sets. The multiple LED sets are electrically connected to the sensation controlling module and respectively have different color temperatures. The sensation controlling module automatically adjusts an integrated illumination of the multiple LED sets for coordinating to the environmental illumination. The sensation controlling module automatically respectively switches on/off the multiple LED sets for adjusting an integrated color temperature of the multiple LED sets for coordinating to the environmental color temperature.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a table lamp for protecting eyes in accordance with the present invention;

FIG. 2 is an enlarged partial plan view of an illumination of the table lamp for protecting eyes in accordance with the present invention;

FIG. 3 is a block diagram of a sensation controlling module of the table lamp for protecting eyes in accordance with the present invention;

FIGS. 4-5 are operational views of the table lamp for protecting eyes in accordance with the present invention;

FIG. 6 is an enlarged partial plan view of an illumination of a second embodiment of the table lamp for protecting eyes in accordance with the present invention; and

FIG. 7 is a block diagram of a sensation controlling module of the second embodiment of the table lamp for protecting eyes in accordance with the present invention.

### DETAILED DESCRIPTION OF THE INVENTION

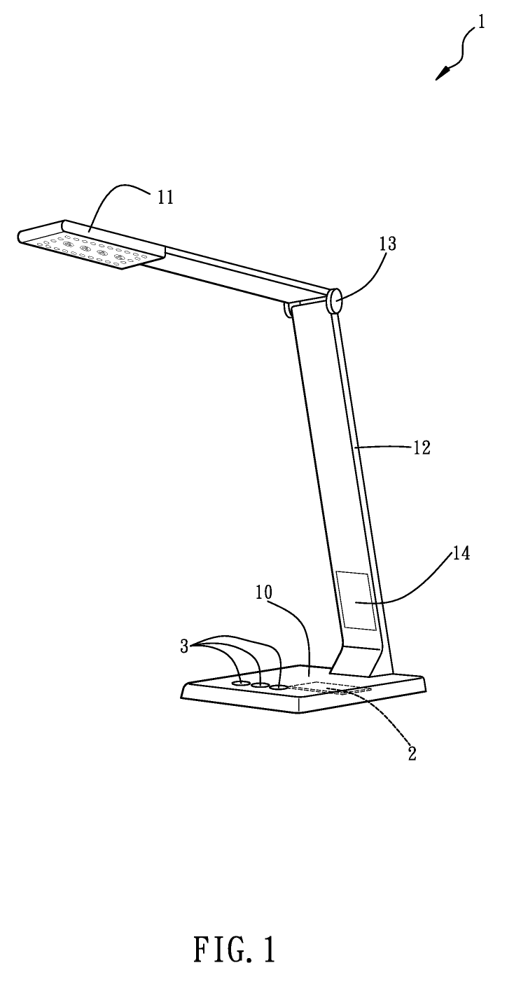

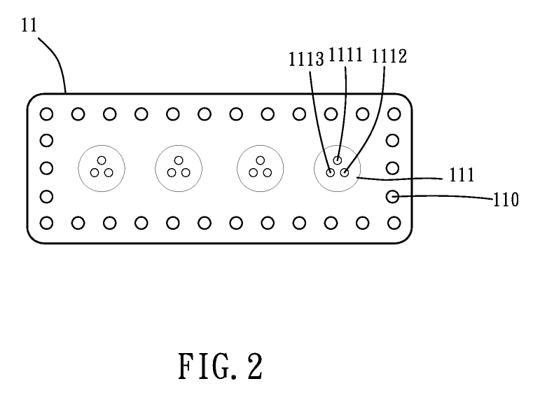

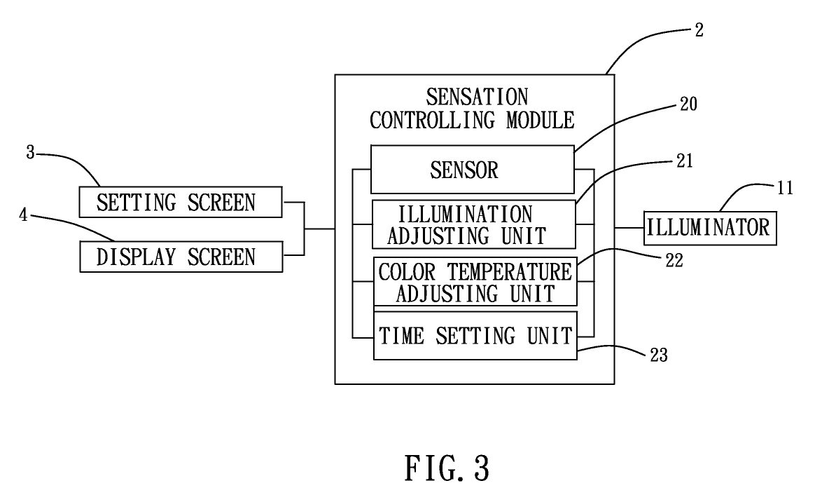

Referring to the drawings and initially to FIGS. 1-6, a table lamp for protecting eyes in accordance with the present invention comprises a base (10) and an illuminator (11) extended from the base (10).

The base (10) is provided for positioned the table lamp (1). The base (10) has a neck (12) extended therefrom. The neck (12) is in a shank shaped. The neck (12) has a joint (13) mounted one end thereof. The illuminator (11) is mounted on the joint (13) for adjustably pivoting relative to the neck (12) to adjust an illuminative area.

The illuminator (11) includes a sensation controlling module (2), multiple white LEDs (110) respectively electrically connected to the sensation controlling module (2), and multiple RGB LED sets (111) respectively electrically connected to the sensation controlling module (2). Each RGB LED set (111) includes a red LED (1111), a green LED (1112), and a blue LED (1113). The LED lamp presents many advantages over traditional light sources including lower energy consumption, longer lifetime, small size and fewer flickers. In the preferred embodiment of the present invention, the multiple RGB LED sets (111) are linearly arranged in a middle of the illuminator (11) and the multiple white LEDs (110) are surroundingly arranged along an edge of the illuminator (11) relative to the multiple RGB LED sets (111) for uniformly emitting lights.

The sensation controlling module (2) includes a sensor (20), an illumination adjusting unit (21), a time setting unit (23), and a color temperature adjusting unit (22). The sensor (20), the illumination adjusting unit (21), the time setting unit (23), and a color temperature adjusting unit (22) are electrically connected to each other. The sensor (20) is provided for detecting an environmental illumination and an environmental color temperature. The illuminator (11) adjusting unit is provided for adjusting an integrated illumination of the multiple white LEDs (110) and the multiple RGB LED sets (111) for coordinating to the environmental illumination. The color temperature adjusting unit (22) is provided for adjusting an integrated color temperature of the multiple RGB LED sets (111) for coordinating to the environmental color temperature. The time setting unit (23) is provided for controlling a time for adjustably switching on/off the multiple white LEDs (110) and the multiple RGB LED sets (111). A setting screen (3) is mounted on the base (10) and electrically connected to the sensation controlling module (2). The setting screen (3) is provided for inputting the time for switching on/off the illuminator (11). A display screen (4) is mounted on the neck (12) and electrically connected to the sensation controlling module (2). The display screen (4) is provided for showing a present illumination and a present color temperature of the illuminator (11).

The table lamp (1) of the present invention has different modes for switching on/off the illuminator (11). The setting screen (3) is operated for respectively/integrally switching on/off the multiple white LEDs (110) and the multiple RGB LED sets (111). The setting screen (3) is operated for setting the time setting unit (23) such that the multiple white LEDs (110) and the multiple RGB LED sets (111) are respectively/integrally switched on/off the multiple white LEDs (110) in a preset time. The setting screen (3) is operated such that the multiple white LEDs (110) and the multiple RGB LED sets (111) are respectively/integrally and gradually brightened/darkened. The setting screen (3) is operated for setting the time setting unit (23) such that the multiple white LEDs (110) and the multiple RGB LED sets (111) are respectively/integrally and gradually brightened/darkened in a preset time.

The table lamp (1) of the present invention provides a manual mode and an automatic mode for adjusting an illumination of the illuminator (11) and a color temperature of the illuminator (11). In the manual mode, a user can manually operate the setting screen (3) for respectively controlling the illuminator (11) adjusting unit and the color temperature adjusting unit (22) such that the illumination and the color temperature of the illuminator (11) are manually adjustable for coordinating to the different environments. In the automatic mode, the sensor (20) automatically detects the environmental illumination and the environmental color temperature. The illumination adjusting unit (21) automatically adjusts the integrated illuminations of the multiple white LEDs (110) and the multiple RGB LED sets (111) for coordinating to the environmental illumination. The color temperature adjusting unit (22) automatically adjusts the integrated color temperature of the multiple RGB LED sets (111) for coordinating to the environmental color temperature. A unit increment of the illumination is lumen (symbol: lm), which is shown on the display screen (4). A unit increment of the color temperature is kelvin (symbol: K), which is shown on the display screen (4).

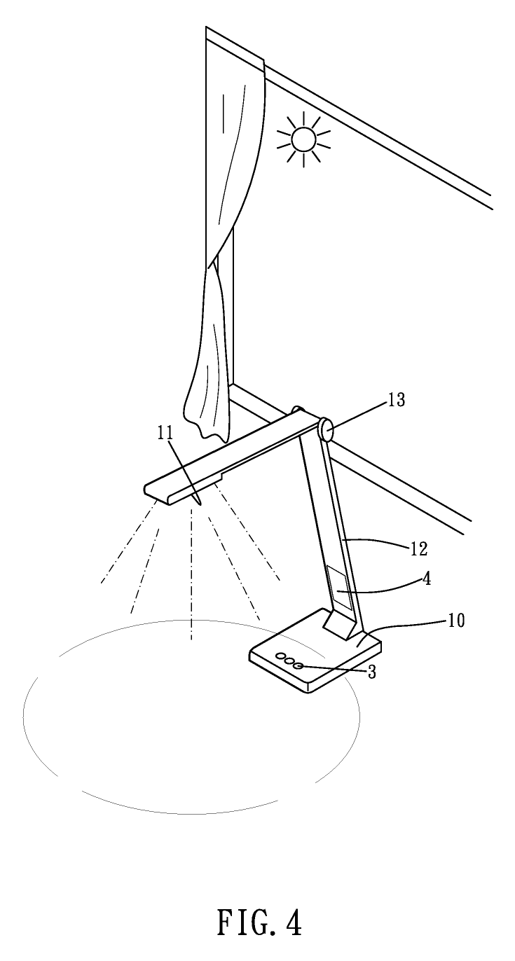

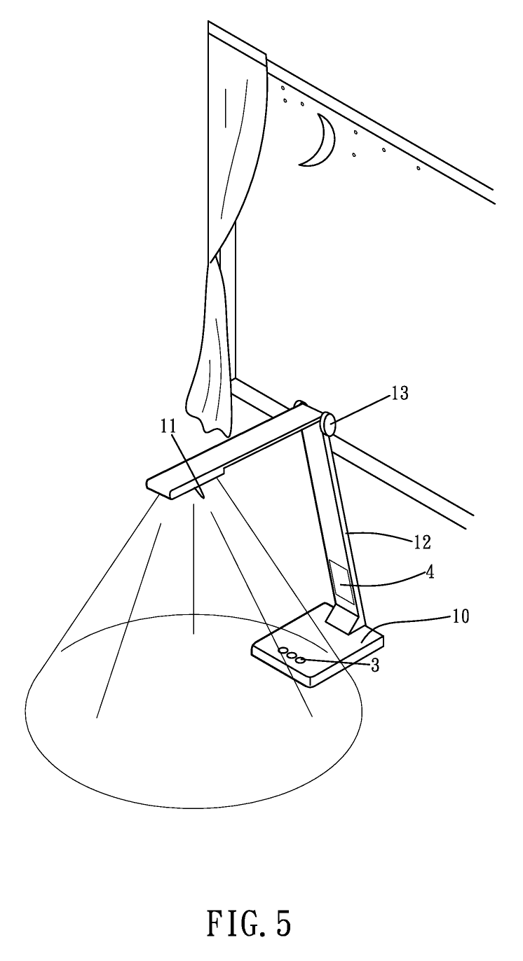

When the environment has a bright/dim illumination in the daytime/nighttime, as shown in FIG. 4/FIG. 5, the illumination adjusting unit (21) automatically adjusts the integrated illumination of the multiple white LEDs (110) and the multiple RGB LED sets (111) for complementarily counteractively coordinating to the environmental illumination. The color temperature adjusting unit (22) automatically adjusts the integrated color temperature of the multiple RGB LED sets (111) for complementarily counteractively coordinating to the environmental color temperature.

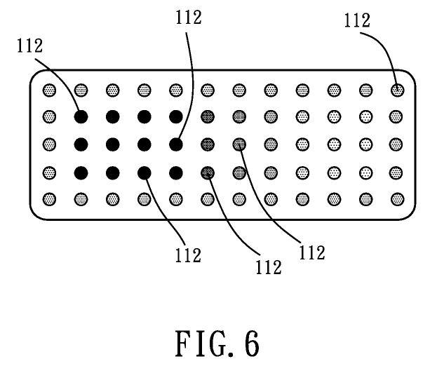

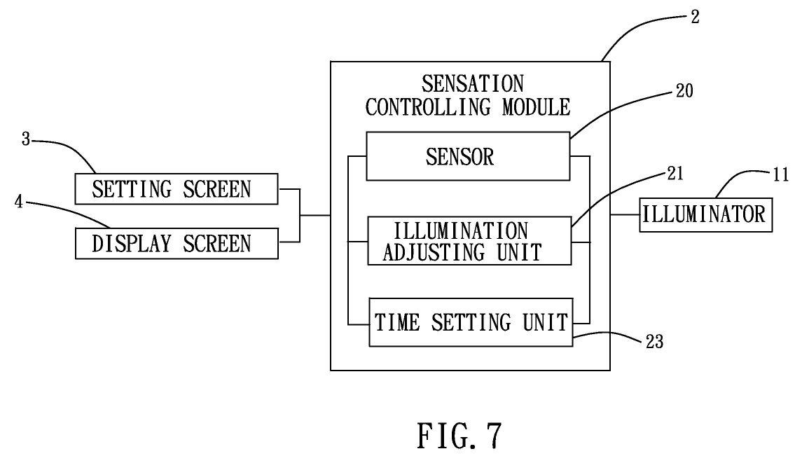

With reference to FIG. 6 and FIG. 7, that shows a second embodiment of the table lamp for protecting eyes in accordance with the present invention. The elements and effects of the second embodiment which are the same with the first embodiment are not described, only the differences are described. The sensation controlling module (2) includes multiple LED sets (112). The multiple LED sets (112) are electrically connected to the sensation controlling module (2) and respectively have different color temperatures. The sensation controlling module (2) includes a sensor (20), an illumination adjusting unit (21), and a time setting unit (23). The sensor (20), the illumination adjusting unit (21), and the time setting unit (23) are electrically connected to each other. The illumination adjusting unit (21) automatically adjusts an integrated illumination of the multiple LED sets (112) for coordinating to the environmental illumination. The illumination adjusting unit (21) automatically respectively switches on/off the multiple LED sets (112) for adjusting an integrated color temperature of the multiple LED sets (112) for coordinating to the environmental color temperature.

Although the invention has been explained in relation to its preferred embodiment, it is to be understood that many other possible modifications and variations can be made without departing from the spirit and scope of the invention as hereinafter claimed.

What is claimed is:

1. A table lamp for protecting eyes comprising:
a base provided for positioning the table lamp; and
an illuminator extended from the base, the illuminator including a sensation controlling module, multiple white LEDs respectively electrically connected to the sensation controlling module, and multiple RGB LED sets respectively electrically connected to the sensation controlling module, each RGB LED set including a red LED, a green LED, and a blue LED, the sensation controlling module automatically detecting an environmental illumination and an environmental color temperature, the sensation controlling module automatically adjusting an integrated illumination of the multiple white LEDs and the multiple RGB LED sets for coordinating to the environmental illumination, the sensation controlling module automatically adjusting an integrated color temperature of multiple RGB LED sets for coordinating to the environmental color temperature;
wherein the sensation controlling module is automatically adjusted the integrated illumination and the integrated color temperature of the illuminator in according with different environments such that the environmental illumination and the environmental color temperature are automatically complementary/counteractive.

2. The table lamp for protecting eyes as claimed in claim 1, wherein the sensation controlling module includes a sensor, an illumination adjusting unit, and a color temperature adjusting unit; the sensor, the illumination adjusting unit, and a color temperature adjusting unit are electrically connected to each other; the sensor automatically detects the environmental illumination and the environmental color temperature; the illumination adjusting unit automatically adjusts the integrated illumination of the multiple white LEDs and the multiple RGB LED sets for coordinating to the environmental illumination; the color temperature adjusting unit automatically adjusts the integrated color temperature of the multiple RGB LED sets for coordinating to the environmental color temperature.

3. The table lamp for protecting eyes as claimed in claim 1, wherein the sensation controlling module includes a time setting unit for controlling a time for switching on/off the illuminator.

4. The table lamp for protecting eyes as claimed in claim 1 further comprising a setting screen electrically connected to the sensation controlling module for inputting a time for switching on/off the illuminator.

5. The table lamp for protecting eyes as claimed in claim 1 further comprising a display screen electrically connected to the sensation controlling module for showing a present illumination and a present color temperature of the illuminator.

6. The table lamp for protecting eyes as claimed in claim 1, wherein the multiple white LEDs and multiple RGB LED sets are gradually brightened/darkened.

7. A table lamp for protecting eyes comprising:
a base provided for positioning the table lamp; and
an illuminator extended from the base, the illuminator including a sensation controlling module and multiple LED sets electrically connected to the sensation controlling module, the multiple LED sets respectively having different color temperatures, the sensation controlling module automatically detecting an environmental illumination and an environmental color temperature, the sensation controlling module automatically adjusting an integrated illumination of the multiple LED sets for coordinating to the environmental illumination, the sensation controlling module automatically respectively switching on/off the multiple LED sets for adjusting an integrated color temperature of the multiple LED sets for coordinating to the environmental color temperature;
wherein the sensation controlling module is automatically adjusted the integrated illumination and the integrated color temperature of the illuminator in according with different environments such that the environmental illumination and the environmental color temperature are automatically complementary/counteractive.

8. The table lamp for protecting eyes as claimed in claim 1, wherein the sensation controlling module includes a sensor and an illumination adjusting unit; the sensor and the illumination adjusting unit are electrically connected to each other, the sensor automatically detecting the illumination and the environmental color temperature, the illumination adjusting unit automatically adjusting the integrated illumination of the multiple LED sets for coordinating to the environmental illumination, the illumination adjusting unit automatically respectively switching on/off the multiple LED sets for adjusting the integrated color temperature of the multiple LED sets for coordinating to the environmental color temperature.

9. The table lamp for protecting eyes as claimed in claim 1, wherein the sensation controlling module includes a time setting unit provided for controlling a time for switching on/off the illuminator.

10. The table lamp for protecting eyes as claimed in claim 1 further comprising a setting screen electrically connected to the sensation controlling module, the setting screen provided for inputting a time for switching on/off the illuminator.

11. The table lamp for protecting eyes as claimed in claim 1 further comprising a display screen electrically connected to the sensation controlling module, the display screen provided for showing a present illumination and a present color temperature of the illuminator.

12. The table lamp for protecting eyes as claimed in claim 1, wherein the LED sets are gradually brightened/darkened.
